(19) United States
(12) Patent Application Publication
(10) Pub. No.: US 2005/0062554 A1
(43) Pub. Date: Mar. 24, 2005

(54) Termination stub system and method

(76) Inventors: Mike Cogdill, Longmont, CO (US); Idis Ramona Martinez, Roseville, CA (US); Derek Steven Schumacher, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/671,120

(22) Filed: Sep. 24, 2003

(51) Int. Cl. H01P 1/26

(52) U.S. Cl. 333/22 R

(57) ABSTRACT

A present invention termination stub system is disclosed. In one embodiment the termination stub system includes a first resistor, a division point, and a second resistor. The first resistor dampens reflections of a signal and is in series with an input signal path. The division point is coupled to the first resistor. The division point divides the signal into a plurality of output communication paths. The second resistor balances resistance of the termination stub system with a characteristic impedance of the signal input path. The second resistor is coupled to the first resistor in parallel with the input signal path and the plurality of output communication paths.

### FIELD OF THE INVENTION

The present invention relates to communications in an electronic system. More particularly, the present invention relates to a system and method for terminating signal communications in a printed circuit board.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, electronic systems designed to provide these advantageous results utilize electrical signals to communicate information. While electrical signals often provide an efficient means of communicating information it is important for the signal integrity to be maintained and interference minimized for systems to operate properly.

Many electronic systems include components mounted on a printed circuit board (PCB). Arranging components on printed circuit boards typically offers a number of advantages. For example, communication paths or traces of printed circuit boards typically provide a convenient and efficient mechanism for coupling components together and simplifying manufacturing activities. Printed circuit boards also usually permit a number of components associated with a sub-system (e.g., a graphics subsystem, network communications subsystem, etc.) to be added or removed conveniently from a system. However, communicating signals accurately in the small confines of a printed circuit board is often problematic and there a number electrical phenomena that can adversely impact signal integrity including cross talk, electromagnetic interference and reflections.

When a signal wave front travels down a communication path and encounters a large and sudden disparity or change in impedance, a reflection is usually produced. For example, when a communication path is coupled to a component for receiving a signal and the component has a relatively large impedance compared to the communication path, a portion of the signal bounces or reflects back. The reflected portion of the signal that “echoes” from the point of sudden impedance change travels in the opposite direction down the communication path. The reflected signal usually interferes with the signal wave front propagating from a transmission device and often results in signal distortions.

A reflection is a form of noise that usually distorts a transmitted signal and can cause a lot of significant problems. For example, data is often communicated in pulse signals and reflections in a pulse signal tend to add or subtract in odd combinations that cause the original pulse to be distorted and corrupted resulting in data loss. For example, high-speed effects of the end-of-line reflections or characteristic impedance changes can include a shift of the edge in time, variation of the slew rate of the edge, and change in signal amplitude. Further complicating the issues is the desire for electronic systems to operate at relatively fast speeds or clock rates. However, as signal frequencies increase a number of “transmission line” type characteristics begin to become more prevalent. As edge rates and transmission rates increase the effective line length tends to increase and if not properly addressed the ability of a system to function reliably and provide accurate results decreases. Reflective distortions in a signal can contribute to signal jitter, cause false triggering in clock lines, and erroneous information on data, address and control lines. With an increase in the signal frequencies, the effect of the parasitic capacitances and inductances also usually increase. The effect of reflections and crosstalk from the parasitic parameters can be seen as discontinuities on the signal edges.

The amount of reflection usually depends on the difference between the termination impedance and the characteristic impedance of the line. The amount of signal return or reflection is usually dependent upon the magnitude of a mismatch between the transmitting impedance (e.g., impedance of the transmitting device plus inherent trace or line impedance characteristics) and impedance characteristics of the receiving devices. The degree of mismatch is usually expressed in terms of the reflection coefficient or voltage standing wave ratio. Sometimes the reflections are expressed in terms of a return loss or the amount of signal reflected back from the termination or receiving device. In short traces a reflection can be strong enough to cause standing waves to be set up on the line.

FIG. 1 is a block diagram of a prior art signal driver and receiver system 100. Prior art signal driver and receiver system 100 includes drivers 110, 120 and 130, termination resistors 112, 122, and 132, a termination voltage 113, 123, and 133 and a receiver 111, 121, and 131. Traditional systems in which there is a driver and termination resistor for each receiver consumes significant precious die space and manufacturing resources.

### SUMMARY OF THE INVENTION

A present invention termination stub system is disclosed. In one embodiment, the termination stub system includes a first resistor, a division point, and a second resistor. The first resistor dampens reflections of a signal and is in series with an input signal path. The division point is coupled to the first resistor. The division point divides the signal into a plurality of output communication paths. The second resistor balances resistance of the termination stub system with a characteristic impedance of the signal input path. The second resistor is coupled to the first resistor in parallel with the input signal path and the plurality of output communication paths.

### BRIEF DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is a block diagram of a prior art signal driver and receiver system.

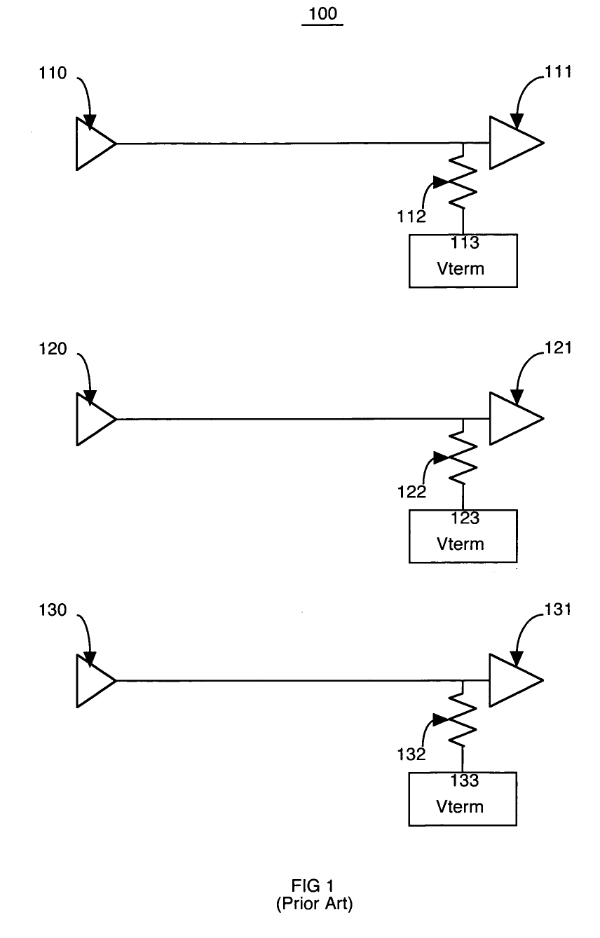

FIG. 2 is a block diagram of a integrated circuit in accordance with one embodiment of the present invention.

FIG. 3 is a flow chart of termination stub method in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some readily understood methods, procedures, components, and circuits have not been described in detail as not to unnecessarily obscure aspects of the current invention.

The present invention facilitates flexible distribution of signals while minimizing reflective distortions. The present invention is capable of minimizing reflective distortions from multiple receivers. In one embodiment the signals are distributed in a manner that provides the reflective distortion interference in a cost effective manner. The present invention also simplifies timing issues.

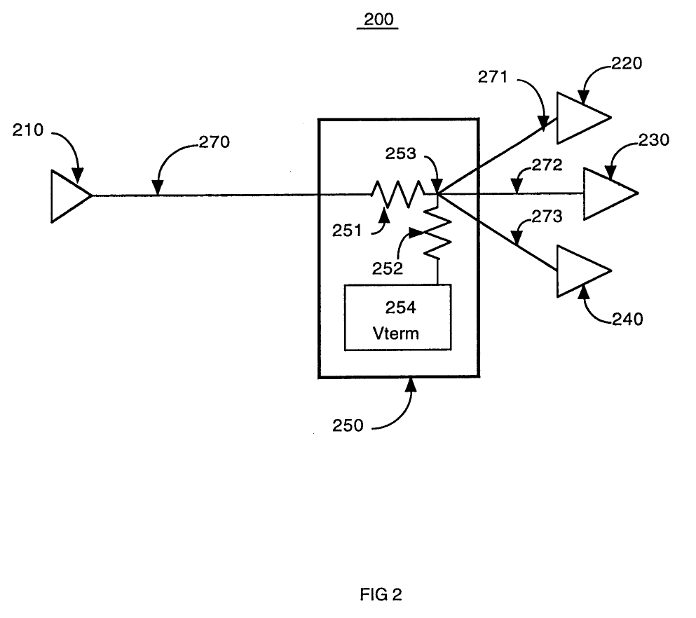

FIG. 2 is a block diagram of integrated circuit 200 in accordance with one embodiment of the present invention. Integrated circuit 200 comprises primary communication path 270, branch communication paths 271, 272 and 273, driver 210, termination stub system 250 and receivers 220, 230 and 240. Primary communication path 270 communicatively couples driver 210 to termination stub system 250. Branch communication paths 271 through 273 communicatively couple termination stub system 250 to receivers 220, through 240 respectively.

The components of integrated circuit 200 cooperatively operate to communicate signals while minimizing reflective distortions. Receivers 220, 230 and 240 receive a signal (e.g., a data signal, control signal, address signal, etc.). Driver 210 drives the signal to receivers 220, 230 and 240. Termination stub system 250 directs the signal to the receivers while minimizing reflection of said signal towards said driver. For example, termination stub system 250 directs a signal from communication path 270 to communication path 271 and receiver 220, communication path 272 and receiver 230, and communication path 273 and receiver 240. It is appreciated that the communication paths (e.g., 271, 272 and 273) can be implemented in a variety of mechanisms. For example, communication paths can be a trace or bus line included in a printed circuit board. In one embodiment, the receivers are memory components included in a memory system and control signal which controls the memory components is communicated via integrated circuit 200.

In one embodiment of the present invention, branch communication paths 271, 272 and 273 are substantially the same length and width and have similar inherent resistance characteristics. In one exemplary implementation, branch signal communication paths 271, 272 and 273 are configured to deliver signal wave fronts at substantially the same time to receivers 220, 230 and 240 respectively.

In one embodiment of the present invention, termination stub system 250 includes a first resistor 251, a second resistor 252, a division point 253 and voltage termination coupler 254. In one exemplary implementation, the input signal path for termination stub system 250 is primary communication path 270 and the output signal paths of termination stub system 250 are branch communication paths 271 through 273. Resistors 251 and 252 resist current flow. The first resistor 251 is in series with an input signal path for termination stub system 250 Division point 253 divides a signal into a plurality of output communication paths. Second resistor 252 is in parallel with an input signal path (e.g., primary communication path 270) and a plurality of output communication paths (e.g., branch communication paths 271 through 273). Second resistor 252 is coupled to a termination voltage 254. In one exemplary implementation, the termination voltage is a steady state voltage level (e.g., quiescent or DC steady state voltage level) for the system.

The components of termination stub system 250 cooperatively operate to minimize reflective distortion on the input signal communication path (e.g., primary communication path 270). In one exemplary implementation, first resistor 251 decreases a voltage level of a signal on the input signal path to division point 253 and dampens reflections of a signal. For example, if a reflective signal is reflected back along an output path (e.g., branch path 271, 272, and/or 273) of termination stub 250, first resistor 251 dampens the reflected signal propagation back towards the input (e.g., primary path 270) of termination stub system 250. For example, first resistor 251 and second resistor 252 can form a voltage divider for reducing a voltage level of the signal at division point 253. First resistor can be sized to reduce overshoot of the signal at receivers (e.g., receivers 220, 230 and 240) coupled to the plurality of output communication paths (e.g., branch communication paths 271, 272, and 273. Second resistor 252 balances the impedance of termination stub system 250 with a characteristic impedance of the signal input path (e.g., primary communication path 270). By balancing the impedance, second resistor minimizes impedance differences between primary communication path 270 and termination stub system 250. In one exemplary implementation the second resistor 252 is sized to match characteristic impedance of the input signal path (e.g., primary communication path 270). In one embodiment, the first resistor 251 is coupled immediately to the second resistor 252 (e.g., first resistor 251 and second resistor 252 form a voltage divider).

In one exemplary implementation of the present invention, driver 210 drives a signal along primary communication path 270. Second resistor 252 balances or matches the characteristic impedance of primary communication path 270 to reduce the impedance differences between primary communication path 270 and termination stub system 250. Since the impedance difference is reduced reflections from termination stub system 250 back towards driver 210 are minimized. First resistor 253 and second resistor 252 act as a voltage driver and drop the voltage of the signal from driver 210. Dropping the voltage of the signal from driver 210 facilitates management of voltage levels and overshoot issues at the receivers 220, 230 and 240. The signal wave front is divided into three signal wave fronts by division point 253 and one signal wave front is communicated along each of branch paths 271, 272 and 273.

The length and width of branch communication paths 271, 272 and 273 is substantially the same and have similar inherent impedance characteristics. Having similar impedance characteristics facilitates reduction of reflective signals from receivers 220, 230 and 240. Having similar lengths minimizes differences in receipt time of a signal wave front at each of the receivers 220, 230 and 240. This also simplifies timing calculation and coordination issues. Since the signal wave fronts arrive at substantially the same time if the receipt timing calculation is performed for one receiver the values can be used in one embodiment for coordination of all the receivers.

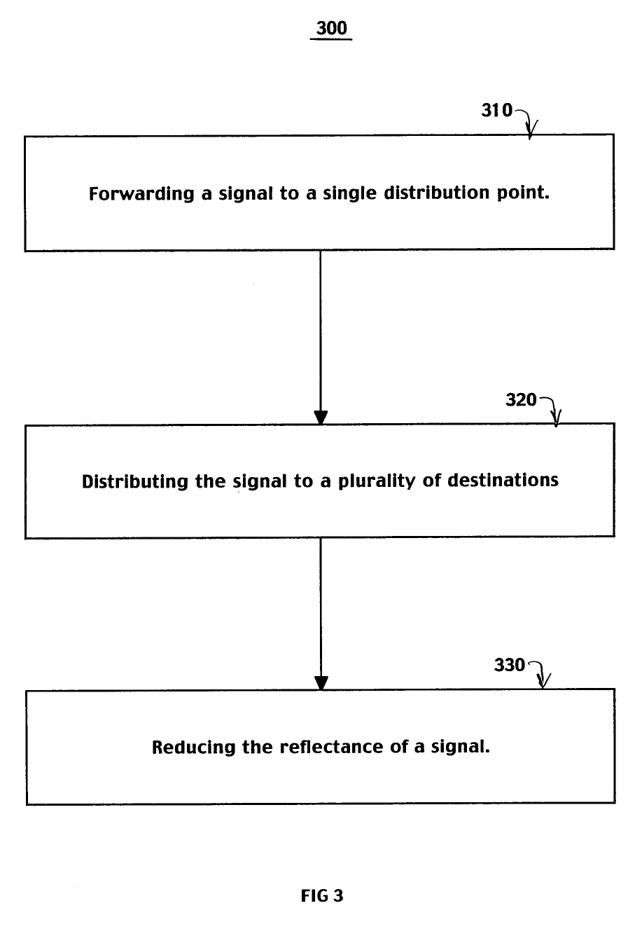

FIG. 3 is a flow chart of termination stub method 300 in accordance with one embodiment of the present invention. Termination method 300 facilitates the reduction of reflective distortions in a signal. In one embodiment of the present invention, termination method 300 also facilitates coordination of signal timing issues.

In step 310, a signal is forwarded to a single distribution point. In one embodiment, the signal is forwarded from a single driver (e.g., driver 210) along a printed circuit board trace (e.g., primary communication path 270). In one exemplary implementation the signal is a control signal in a memory subsystem. For example, the control signal can be a chip select signal.

In step 320, the signal is distributed to a plurality of destinations. For example, a signal along a single path is received. The signal is split into a plurality of signal wave fronts. In one embodiment, the signal is directed along a plurality of communication paths that are the same length and width. In one exemplary implementation the wave fronts of the signal are received concurrently at the plurality of destinations.

In step 330, reflectance of the signal is reduced. In one embodiment, a termination voltage is supplied and a characteristic transmission impedance is matched. For example, a first resistor in series with an input (e.g., resistor 251) and a second resistor in parallel with the input (e.g., resistor 252) substantially match the characteristic impedance of the input communication path (e.g., primary communication path 270). In one embodiment of the present invention overshoot conditions are managed. For example, the voltage level of a plurality of receiver input signals is reduced.

In one embodiment, a present invention termination stub system is included in a random access memory (RAM) subsystem. The RAM subsystem includes a memory interface component and a plurality of memory chips. In one exemplary implementation, each memory chip (e.g., a dual in-line memory module or DIMM) includes an array of memory cells arranged in rows and columns (e.g., with the rows extending along a horizontal direction and the columns extending along a vertical direction). Electrically conductive elements functioning as word lines extend along the rows. Electrically conductive elements functioning as bit lines extend along the columns. In one example, there is one word line for each row of the array and one bit line for each column of the array. Electrically conductive elements functioning as read lines also extend along either rows or columns. In one embodiment, the memory interface also includes row decoders, column decoders, and read/write logic components.

The memory components cooperatively operate to read and write information. During a read operation on a selected cell a read control signal is driven on a word line associated with the memory cell being written. In one embodiment of the present invention, the memory cell acts as a receiver of the control signal and a present invention termination stub system is coupled to the word line. During a write operation on a selected cell a write control signal is driven on a bit line associated with the memory cell being written. In one embodiment of the present invention the memory cell acts as a receiver of the control signal and a present invention termination stub system is coupled to the bit line.

In one embodiment of the present invention, the memory interface (e.g., an application specific integrated circuit or ASIC) controls communications between a processor and the memory cells. In one exemplary implementation the memory interface controls communications between the memory and multiple processors (e.g., a multi-socket central processing unit or CPU configuration). A driver (e.g., drive 210) in the memory interface drives a control signal (e.g., a chip select signal) on a control line (e.g., primary communication path 270) to a plurality of buffers included in the memory interface which in turn amplify the signal and forward it to memory module chips (e.g., a DIMM).

Thus, the present invention facilitates flexible distribution of signals while minimizing reflective distortions. The present invention is capable of minimizing reflective distortions from multiple receivers. In one embodiment the signals are distributed in a manner that provides the reflective distortion interference in a cost effective manner. For example, a single termination stub system is utilized to distribute a signal from and single source (e.g., driver) to multiple destinations (e.g. receivers) and reduce reflective interference from the multiple receivers. The use of one resistor to mitigate reflective distortions from a plurality of receivers also facilitates conservation of resources and precious printed circuit board space. The present invention can also simplify timing issues. For example, signals arrive at multiple receivers at substantially the same time, thus reducing the number of timing calculations. Calculating the timing for one receiver provides a timing solution for the plurality of receivers.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various modifications as are suited to the particular use contemplated. It is intended that the scope of the invention be defined by the claims appended hereto and their equivalents.

1. A termination stub system comprising:
a first resistor for dampening reflections of a signal, said first resistor in series with an input signal path;
a division point for dividing said signal into a plurality of output communication paths, wherein said plurality of output communication paths are substantially the same length, said division point coupled to said first resistor; and
a second resistor for balancing resistance of a termination stub system with a characteristic impedance of said signal input path, said second resistor in parallel with said input signal path and said plurality of output communication paths and said second resistor coupled to said first resistor.

2. A termination stub system of claim 1 wherein said first resistor and said second resistor form a voltage divider for reducing a voltage level of said signal at said division point.

3. A termination stub system of claim 1 wherein said first resistor is sized to reduce overshoot of said signal at receivers coupled to said plurality of output communication paths.

4. A termination stub system of claim 1 wherein said second resistor is coupled to a termination voltage.

5. A termination stub system of claim 5 wherein said termination voltage is a steady state voltage.

6. A termination stub system of claim 1 wherein said input signal path and said plurality of output communication paths are trace lines in a printed circuit board.

7. A termination stub system of claim 1 wherein said first resistor is coupled immediately to said second resistor.

8. An integrated circuit comprising:
a plurality of receivers for receiving a signal;
a driver for driving said signal to said plurality of receivers; and
a termination stub system for directing said signal to said receivers while minimizing reflection of said signal towards said driver, wherein said termination stub system includes a plurality of substantially equal length branch signal communication paths coupled to said plurality of receivers.

9. An integrated circuit of claim 8 wherein said integrated circuit is a printed circuit board.

10. An integrated circuit of claim 8 wherein said plurality of branch signal communication paths are the same length.

11. An integrated circuit of claim 10 wherein said plurality of branch signal communication paths are configured to deliver said signal.

12. An integrated circuit of claim 11 wherein said signal is a control signal.

13. An integrated circuit of claim 12 wherein said receivers are memory components included in a memory system and said control signal controls said memory components.

14. An integrated circuit of claim 13 wherein said control signals are chip select signals.

15. A termination stub method comprising:
forwarding a signal to a single distribution point;
distributing said signal to a plurality of destinations;
reducing reflectance of said signal by creating a termination voltage and
matching a characteristic transmission impedance; and
directing said signal along a plurality of communication paths that are substantially the same length.

16. A termination stub method of claim 15 further comprising managing overshoot conditions.

17. A termination stub method of claim 15 wherein said distributing further comprises:
receiving a signal along a single path; and
splitting said signal into a plurality of signal wave fronts along said plurality of communication paths.

18. (Cancelled)

19. A termination stub method of claim 15 wherein wave fronts of said signal are received concurrently.

20. (Cancelled).
